(19) United States
(12) Patent Application Publication
(10) Pub. No.: US 2010/0172142 A1
(43) Pub. Date: Jul. 8, 2010

(54) LIGHTING DEVICE FOR TOOLS AND TOOLBOXES

(76) Inventor: Chang Ming-Chi, Taichung City (TW)

Correspondence Address: Chien-Hui Su, P. O. Box 70-121 Taichung, Taichung City, 40899, TW

(21) Appl. No.: 12/349,499

(22) Filed: Jan. 6, 2009

(51) Int. Cl. F21V 15/01; F21V 19/00

(52) U.S. Cl. 362/370; 362/362

(57) ABSTRACT

A lighting device for tools and toolboxes includes a lighting unit and a control unit. The lighting unit includes a housing, an illuminating assembly received in the hosing, and a knob connected one end of the housing. The knob is rotatably moved to control the illuminating assembly. The control unit is laterally mounted to the housing. The control unit is electrically connected to the illuminating assembly. The control unit has a button for controlling the illuminating assembly. When the illuminating assembly is illuminating, the button is pressed to switch off the illuminating assembly. After releasing the button, the illuminating assembly is illuminating.

### BACKGROUND OF THE INVENTION

1. Field of the Invention

The present invention relates to a lighting device, and more particularly to a lighting device for tools and toolboxes.

2. Description of Related Art

A conventional lighting device in accordance with the prior art comprises a mounting mechanism to be mounted to at least one of a support surface of a tool and a support surface in the vicinity of the tool, and a light housing carried by the mounting mechanism. The light housing has at least one LED and at least one power source to power at least one LED to illuminate a work area for a tool.

Due to the limitation of the mounting mechanism, the conventional lighting device can only be adapted to be used with the shank of the tools. The flexibility of the conventional lighting device is limited. Furthermore, the conventional lighting device can not be adapted to be used in the toolbox such that user has to search tools in darkness.

The present invention has arisen to mitigate and/or obviate the disadvantages of the conventional lighting device.

### SUMMARY OF THE INVENTION

The main objective of the present invention is to provide an improved lighting device that provides flexibility in being adapted to be used in tools and toolboxes.

To achieve the objective, the lighting device for tools and toolboxes includes a lighting unit and a control unit. The lighting unit includes a housing, an illuminating assembly received in the hosing, and a knob connected one end of the housing. The knob is rotatably moved to control the illuminating assembly. The control unit is laterally mounted to the housing. The control unit is electrically connected to the illuminating assembly. The control unit has a button for controlling the illuminating assembly. When the illuminating assembly is illuminating, the button is pressed to switch off the illuminating assembly. After releasing the button, the illuminating assembly is illuminating.

The knob further has a magnet received therein for adapting to be connected to a tool or a toolbox.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a lighting device for tools and toolboxes in accordance with the present invention;

FIG. 2 is an assembled perspective view of the lighting device for tools and toolboxes in accordance with the present invention;

FIGS. 3 and 4 are partial cross-sectional views of the lighting device in accordance with the present invention, showing the operations of the lighting device;

FIGS. 5 and 6 show the operations of the lighting device in accordance with the present invention when the lighting device is adapted to be connected a toolbox; and

FIG. 7 shows the operation of the lighting device in accordance with the present invention when the lighting device is adapted to be connected to a spanner.

### DETAILED DESCRIPTION OF THE INVENTION

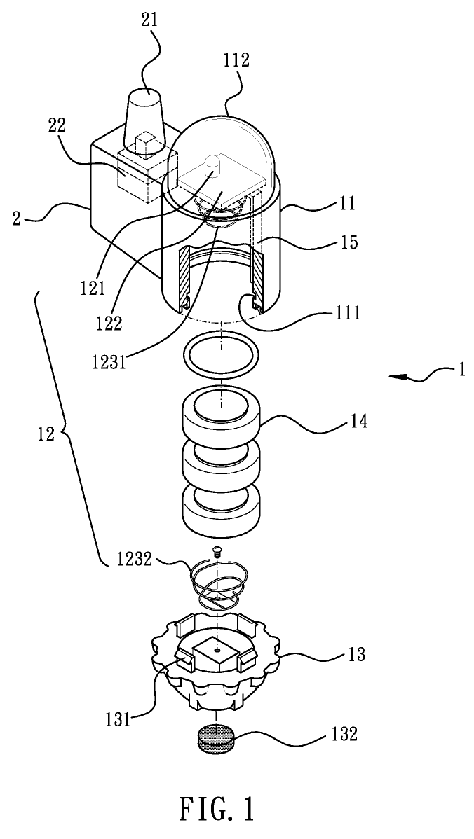

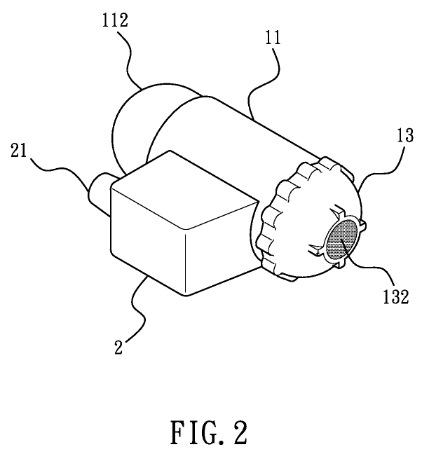

Referring to the drawings and initially to FIGS. 1-4, a lighting device for tools and toolboxes in accordance with the present invention comprises a lighting unit 1 and a control unit 2 connected to the lighting unit 1.

The lighting unit 1 includes a housing 11, an illuminating assembly 12 received in the housing 11, a knob 13 connected to one end of the housing 11. The housing 11 is in a form of a cylinder and hollow for receiving the illuminating assembly 12. The knob 13 is rotatably connected to one end of the hosing 11 for preventing the illuminating assembly 12 from dislocating. A transparent cover 112 is mounted to the other end of the hosing 11 opposite to the knob 13 for preventing the illuminating assembly 12 from dislocating. The transparent cover 112 also permits light passing through. The illuminating assembly 12 includes a lamp 121, a circuit board 122 electrically connected to the lamp 121, a first conductive spring 1231 electrically connected to the circuit board 122, a second conductive spring 1232 mounted to the knob 13, and a battery 14. The lamp 121 is a LED lamp. The battery 14 is disposed between the first conductive spring 1231 and the second conductive spring 1232. One end of the battery 14 is electrically connected to the first conductive spring 1231. The other end of the battery 14 is electrically connected to the second conductive spring 1232. The illuminating assembly 12 further includes a conductive member 15 electrically connected to the circuit board 122. The conductive member 15 is selectively electrically connected to the second conductive spring 1232. The housing 11 has an annular groove 111 defined in an inner peripheral thereof. The knob 13 has multiple hooks 131 extended therefrom. Each hook 131 engages with the annular groove 111 such that the knob 13 rotatably moves relative to the housing 11. The knob 13 further comprises a magnet 132 received therein such that the lighting device is adapted to be connected to any tools.

The control unit 2 is laterally mounted to the housing 11. The control unit 2 includes a control circuit board 22 electrically connected to the circuit board 122 of the illuminating assembly 12 and a button 21 electrically connected to the control circuit board 22. User can press the button 21 to control the lamp 121 of the illuminating assembly 12. When the lamp 121 is illuminating, user can press the button 21 to switch off the lamp 121. After releasing the button 21, the lamp 121 is illuminating again.

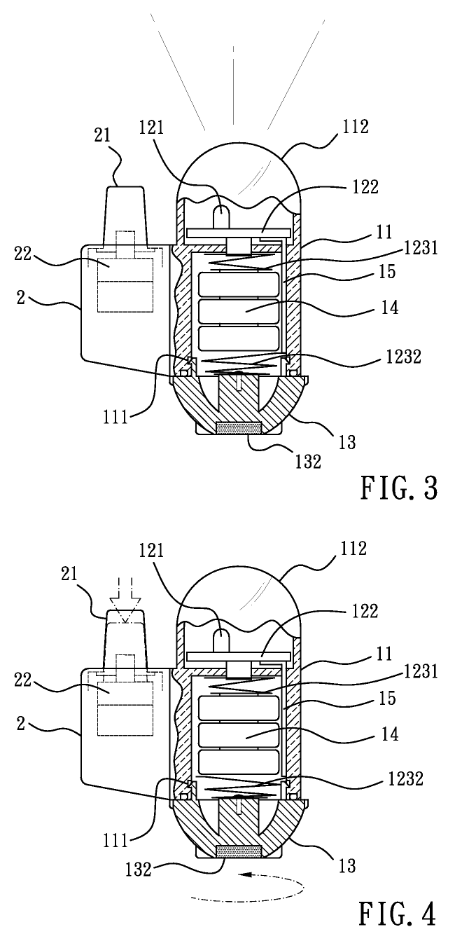

Referring to FIGS. 3 and 4, the operations of the lighting device in accordance with the present invention are illustrated. When the second conductive spring 1232 is electrically connected to the conductive member 15 as shown in FIG. 3, the lamp 121 of the illuminating assembly 12 is illuminating. When rotating the knob 13, the second conductive spring 1232 is driven to rotate with the knob 13. Therefore the second conductive spring 1232 is electrically disconnected to the conductive member 15 as shown in FIG. 4 such that the lamp 121 of the illuminating assembly 12 is not illuminating.

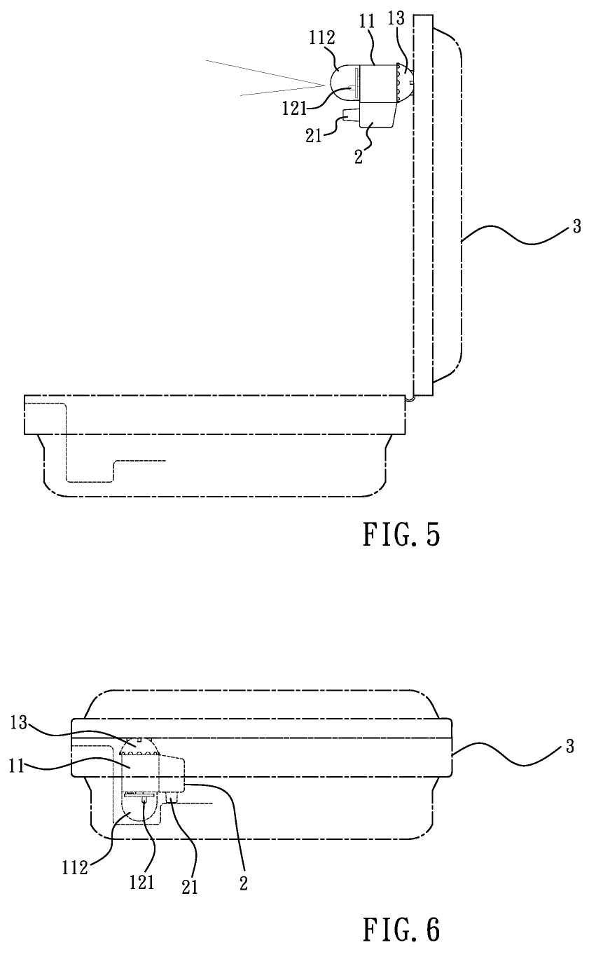

Referring to FIGS. 5 and 6, the lighting device in accordance with the present invention is adapted to be connected to a toolbox 3. When closing the toolbox 3, the button 21 is pressed such that the lamp 121 is not illuminating as shown in FIG. 6. When opening the toolbox 3, the button 21 is released such that the lamp 121 is illuminating as shown in FIG. 5. Therefore, user can find the tool easily and correctly.

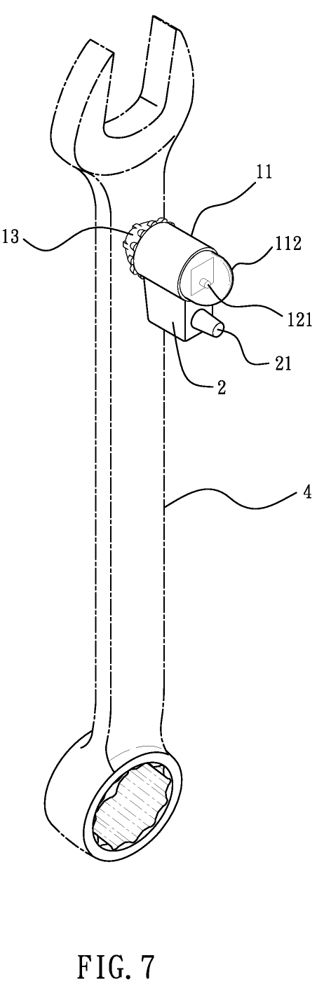

Referring to FIG. 7, the lighting device in accordance with the present invention is adapted to be connected to a spanner 4. The magnet 132 provides the magnetic attraction to attach the lighting device to any tools.

Although the invention has been explained in relation to its preferred embodiment, it is to be understood that many other possible modifications and variations can be made without departing from the spirit and scope of the invention as hereinafter claimed.

What is claimed is:

1. A lighting device for tools and toolboxes, comprising:
a lighting unit comprising a housing, an illuminating assembly received in the hosing, and a knob rotatably connected one end of the housing, wherein the knob rotates to control the illuminating assembly; and
a control unit laterally mounted to the housing, the control unit electrically connected to the illuminating assembly, the control unit having a button for controlling the illuminating assembly;
wherein when the illuminating assembly is illuminating, the button is pressed to switch off the illuminating assembly; after releasing the button, the illuminating assembly is illuminating.

2. The lighting device for tools and toolboxes as claimed in claim 1, wherein the knob has a magnet received therein for adapting to be connected to a tool.

3. The lighting device for tools and toolboxes as claimed in claim 1, wherein the illuminating assembly includes a lamp, a circuit board electrically connected to the lamp, a first conductive spring electrically connected to the circuit board, a second conductive spring mounted to the knob, a battery electrically connected to the first conductive spring and the second conductive spring, and a conductive member electrically connected to the circuit board and selectively electrically connected to the second conductive spring.

4. The lighting device for tools and toolboxes as claimed in claim 1, wherein the knob has multiple hooks extended therefrom; the housing has an annular groove defined therein; the multiple hooks engage with the annular groove such that the knob is rotatably connected to the housing.

5. The lighting device for tools and toolboxes as claimed in claim 1 further comprising a transparent cover mounted to one end of the housing opposite to the knob.
